(19) United States
(12) Patent Application Publication
(10) Pub. No.: US 2006/0199448 A1
(43) Pub. Date: Sep. 7, 2006

(54) Portable positioning device and the method thereof

(75) Inventors: Cheng-Feng Chao, Changhua County (TW); Chang-Hung Lee, Yunlin County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/365,948

(22) Filed: Mar. 2, 2006

(30) Foreign Application Priority Data
Mar. 4, 2005 (TW) 094106523

(51) Int. Cl. H01R 13/73

(52) U.S. Cl. 439/894

(57) ABSTRACT

A portable device for transmitting a positioning information to a remote device is disclosed, which comprises: a positioning unit, for acquiring the positioning information; a timing unit, for calculating a first time interval and a second time interval; a calculating unit, coupled to the positioning unit and the timing unit, for calculating a speed parameter according to the first time interval and the distance of two positioning information acquired within the first time interval; and a transmission unit, coupled to the speed calculating unit and the timing unit, being defined to transmit the positioning information in every second time interval while the second time interval is change with respect to the speed parameter.

### FIELD OF THE INVENTION

The present invention relates to portable positioning device and method thereof, and more particularly, to a portable positioning device and method thereof capable of changing the transmission interval with respect to the moving speed.

### BACKGROUND OF THE INVENTION

With rapid advance of technology, electronic devices are becoming essentials for our daily life. Among those, the portable electronic devices like portable phone, Personal Digital Assistant (PDA), and so on, that can be carried while walking around had facilitated our life ever further. Especially, those portable devices with positioning and navigation capabilities are becoming more and more popular. Generally, the kind of portable devices employ the technologies of Global Positioning System, network-based positioning such as GPRS/GSM, or the combination of the two, for acquiring positioning information.

GSM is short for Global System for Portable communication, which was first introduced in 1991 and, as of the end of 1997, GSM service was available in more than 100 countries and has become the de facto standard in Europe and Asia. GPRS is short for General Packet Radio Service, being a standard for wireless communications which runs at speeds up to 115 kilobits per second, compared with current GSM (Global System for Portable Communications) systems' 9.6 kilobits. GPRS, which supports a wide range of bandwidths, is an efficient use of limited bandwidth and is particularly suited for sending and receiving small bursts of data, such as e-mail and Web browsing, as well as large volumes of data. GPS is short for Global Positioning System, which is funded by and controlled by the U.S. Department of Defense (DOD). While there are many thousands of civil users of GPS world-wide, the system was designed for and is operated by the U.S. military. GPS provides specially coded satellite signals that can be processed in a GPS receiver, enabling the receiver to compute position, velocity and time.

Conventionally, if two persons, i.e. individual A and individual B, are scheduled to meet at a place unfamiliar to both, it will be helpful that each uses a handheld device with GPS capability to acquire one's positioning information and then uses the short message service (SMS) provided by GSM/GPRS to inform the other with his positioning information so that the individuals A and B can locate each other immediately.

Nevertheless, current portable positioning devices are designed to acquire/send a positioning information with respect to a specific time interval, e.g. in every five minutes. In a condition that the person with a portable positioning device is stuck in a traffic jam while the portable positioning device is constantly transmitting the acquired positioning information in every five minutes, it is not a cost effective way for the portable positioning device to operate. It is required to have an improved operation algorithm to overcome the problem.

### SUMMARY OF THE INVENTION

The primary object of the invention is to provide a portable positioning device capable of changing the transmission interval thereof with respect to its moving speed.

It is another object of the invention to provide a portable positioning device capable of issuing an alerting signal while a user of the portable positioning device is deviated from a destination.

To achieve the above objects, the present invention provides a portable device for transmitting a positioning information to a remote device, comprising:
a positioning unit, for acquiring the positioning information;
a timing unit, for calculating a first time interval and a second time interval;
a calculating unit, coupled to the positioning unit and the timing unit, for calculating a speed according to the first time interval and the distance of two positioning information acquired within the first time interval; and
a transmission unit, coupled to the speed calculating unit and the timing unit, being defined to transmit the positioning information in every second time interval while the second time interval is change with respect to the speed.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view showing the architecture of a portable device of the invention.

FIG. 2 is a schematic view showing the architecture of a portable device according to a preferred embodiment of the invention.

FIG. 3 is the flowchart of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

The present invention provides a portable positioning device, capable of minimize the amount of transmissions required by adjusting the transmission interval of the device with respect to a speed parameter.

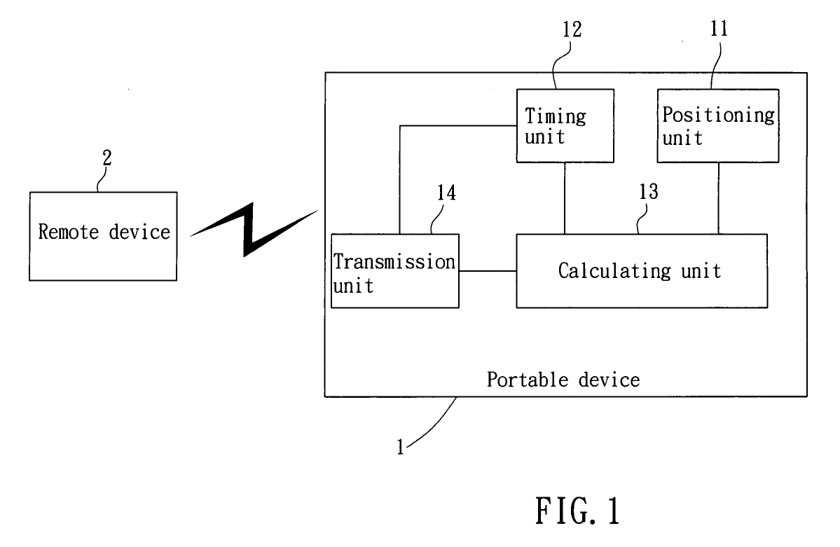

Please refer to FIG. 1, which is a schematic view showing the architecture of a portable device of the invention. As seen in FIG. 1, a portable device 1 for transmitting a positioning information to a remote device 2 is disclosed, which comprises a positioning unit 11, a timing unit 12, a calculating unit 13 and a transmission unit 14. The positioning unit 11 is used for calculating and determining the position of the portable device 1. The timing unit 12 is used for calculating a first time interval and a second time interval. The calculating unit 13 is used for calculating a speed parameter by a function of dividing the distance of two positioning information acquired within the first time interval. Moreover, in a preferred embodiment of the invention, one of the two positioning information is acquired at the beginning of the first time interval while another positioning information is acquired at the end of the first time interval. The transmission unit 14 is defined to transmit the positioning information in every second time interval while the second time interval is change with respect to the speed parameter.

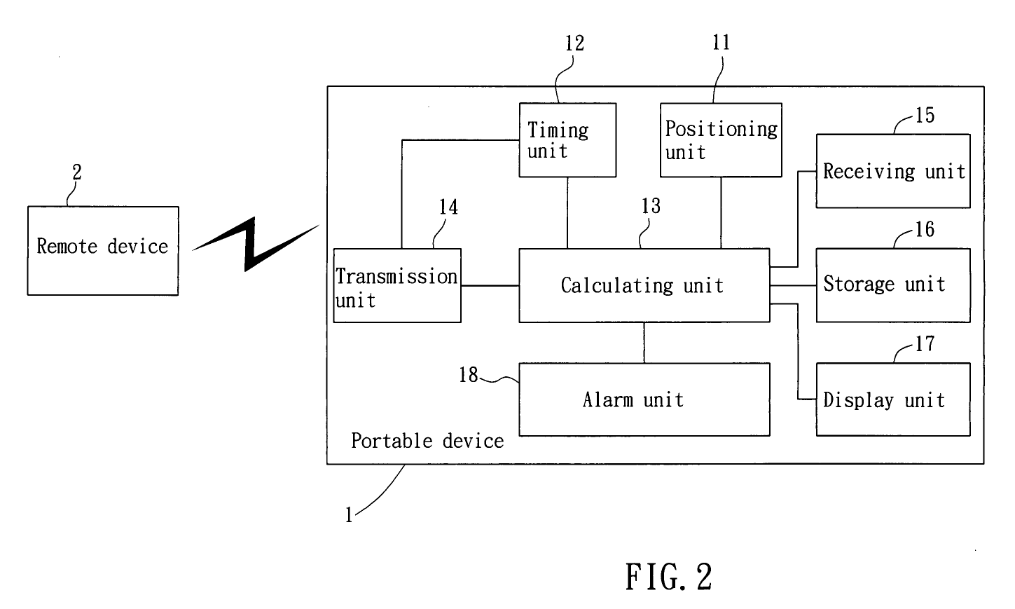

In FIG. 2, another portable device according to a preferred embodiment of the invention is disclosed. The portable device 1 of the embodiment comprises a positioning unit 11, a timing unit 12, a calculating unit 13 and a transmission unit 14. The positioning unit 11 is used for calculating and determining the position of the portable device 1, which can be a satellite positioning device capable of acquiring positioning information by GPS. In another preferred embodiment, the positioning unit 11 can acquire positioning information by the transmission of GPRS if the positioning information of the base stations thereof are accurate enough. The timing unit 12 is used for calculating a first time interval and a second time interval. The calculating unit 13 is used for calculating a speed parameter. The transmission unit 14 is defined to transmit the positioning information in every second time interval while the second time interval is change with respect to the speed parameter. Generally, the second time interval is inversely related to the change of the speed parameter. That is, the faster the speed parameter represents, the smaller the second time interval will be so that a positioning information of the portable device will be transmitted to a remote device in a higher frequency, and vice versa.

In the embodiment shown in FIG. 2, the portable device 1 further comprises a receiving unit 15, a storage unit 16, and a display unit 17. The receiving unit 15 is used for receiving a remote positioning information defining the position of the remote device 2, which may the position of a destination like a friend's house. The storage unit 16 is used for storing a map and the remote positioning information. The display unit 17 is used for displaying the positions of the portable device 1 and the remote device 2 on the map, so that an user of the portable device 1 will have a general idea about the relative positioning of his current position and his destination by the information displayed on the display unit 17.

In addition to the speed parameter, the calculating unit 13 can be used to calculate another parameter representing a suggested moving direction of the portable device 1, which can be acquired with respect to the first time interval, the positioning information of the portable device 1 and the remote positioning information of the remote device 2. By the parameter representing the suggested moving direction, the user of the portable device is informed whether or not he is moving in the direction toward the destination. The portable device 1 of FIG. 2 further comprises an alarm unit for issuing an alerting signal while an estimated distance exceeds a specific value, wherein the estimated distance is calculated by the calculating unit with respect to the positioning information of the portable device and the remote positioning information of the remote device. In addition, the alarm unit is enabled to issue the alerting signal while the suggested moving direction deviates from a specific direction by a predetermined angle. The issuing of the alerting signal can remind the user of the portable device 1 that he is moving in a wrong direction.

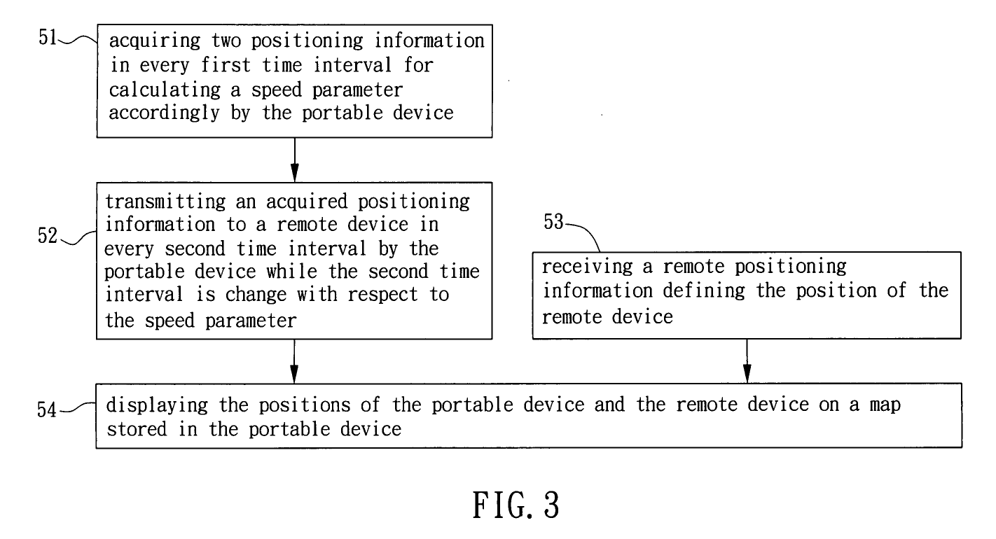

Please refer to FIG. 3, which is a flowchart depicting the positioning method of the invention. The positioning method adapted for a portable device and a remote device, comprises the steps of:
step 51: acquiring two positioning information in every first time interval for calculating a speed parameter accordingly by the portable device, wherein the portable device can acquire the positioning information by GPS or by the transmission of GPRS;
step 52: transmitting an acquired positioning information to the remote device in every second time interval by the portable device while the second time interval is change with respect to the speed parameter, wherein the second time interval is inversely related to the change of the speed parameter, i.e. the faster the speed parameter represents, the smaller the second time interval will be so that a positioning information of the portable device will be transmitted to the remote device in a higher frequency, and vice versa;
step 53: receiving a remote positioning information defining the position of the remote device; and
step 54: displaying the positions of the portable device and the remote device on a map stored in the portable device.

In a preferred embodiment of the invention, the positioning method of the invention further comprises the steps of:
calculating an estimated distance according to the positioning information of the portable device and the remote position information of the remote device; and
issuing an alerting signal while the estimated distance exceeds a specific value.

In another preferred embodiment of the invention, the positioning method of the invention further comprises the steps of:
calculating and acquiring a suggested moving direction for the portable device according to the first time interval, the positioning information of the portable device and the remote positioning information of the remote device; and
issuing an alerting signal while the suggested moving direction deviates from a specific direction by a predetermined angle.

By the positioning method disclosed above, a user of the portable device will be about to have a general idea about the relative positioning of his current position and his destination and thus can minimize the amount of transmissions of the portable device by adjusting the transmission frequency according to his moving speed. In addition, a suggest moving direction and the estimated distance between his current position and his destination can be calculated so that the user can be alerted while he is stray away from his destination.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A portable device for transmitting a positioning information to a remote device, comprising:
a positioning unit, for acquiring the positioning information;
a timing unit, for calculating a first time interval and a second time interval;
a calculating unit, coupled to the positioning unit and the timing unit, for calculating a speed parameter according to the first time interval and the distance of two positioning information acquired within the first time interval; and
a transmission unit, coupled to the calculating unit and the timing unit, for transmitting the positioning information in every second time interval while the second time interval is change with respect to the speed parameter.

2. The device of claim 1, wherein the second time interval is inversely related to the change of the speed parameter.

3. The device of claim 1, wherein the positioning information is acquired by the transmission of GPRS.

4. The device of claim 1, wherein the positioning unit is a satellite positioning unit.

5. The device of claim 1, further comprising:
a receiving unit, for receiving a remote positioning information defining the position of the remote device.

6. The device of claim 5, further comprising:
a storage unit, for storing a map; and
a display unit, for displaying the positions of the portable device and the remote device on the map.

7. The device of claim 5, further comprising:
an alarm unit, for issuing an alerting signal while an estimated distance exceeds a specific value;
wherein the estimated distance is calculated by the calculating unit with respect to the positioning information and the remote positioning information.

8. The device of claim 5, wherein a suggested moving direction of the portable device is calculated and acquired by the calculating unit with respect to the first time interval, the positioning information of the portable device and the remote positioning information of the remote device.

9. The device of claim 5, wherein the alarm unit issues the alerting signal while the suggested moving direction deviates from a specific direction by a predetermined angle.

10. A positioning method, adapted for a portable device and a remote device, comprising the steps of:
acquiring two positioning information in every first time interval and calculating a speed parameter accordingly by the portable device;
transmitting the positioning information to the remote device in every second time interval by the portable device while the second time interval is change with respect to the speed parameter.

11. The method of claim 10, wherein the second time interval is inversely related to the change of the speed parameter.

12. The method of claim 10, wherein the portable device acquires the positioning information by the transmission of GPRS.

13. The method of claim 10, wherein the portable device acquires the positioning information by satellite positioning.

14. The method of claim 10, further comprises the step of:
receiving a remote positioning information defining the position of the remote device.

15. The method of claim 14, further comprising the step of:
displaying the positions of the portable device and the remote device on a map stored in the portable device.

16. The method of claim 14, further comprising the step of:
calculating an estimated distance according to the positioning information of the portable device and the remote position information of the remote device;
issuing an alerting signal while the estimated distance exceeds a specific value.

17. The method of claim 14, further comprising the step of:
calculating and acquiring a suggested moving direction for the portable device according to the first time interval, the positioning information of the portable device and the remote positioning information of the remote device;
issuing an alerting signal while the suggested moving direction deviates from a specific direction by a predetermined angle.
